(19) United States
(12) Patent Application Publication
(10) Pub. No.: US 2022/0399138 A1
(43) Pub. Date: Dec. 15, 2022

(54) FLEXIBLE FLAT CABLE MANUFACTURING METHOD AND FLEXIBLE FLAT CABLE

(71) Applicant: LUXSHARE-ICT CO., LTD., Taipei City (TW)

(72) Inventor: Cheng-Da YANG, Taipei City (TW)

(73) Assignee: LUXSHARE-ICT CO., LTD., Taipei City (TW)

(21) Appl. No.: 17/511,995

(22) Filed: Oct. 27, 2021

(30) Foreign Application Priority Data
Jun. 9, 2021 (CN) 202110642614.X

(51) Int. Cl. H01B 3/44; H01B 7/08

(52) U.S. Cl. CPC H01B 3/44; H01B 7/08

(57) ABSTRACT

The present disclosure provides a flexible flat cable manufacturing method and a flexible flat cable. The steps of the manufacturing method are firstly obtaining a conductor, secondly doping a granule made of fluororesin into a resin to produce a mixed resin and the mixed resin is covering the periphery of the conductor, finally covering the periphery of the mixed resin with a plastic film layer. The flexible flat cable can be produced according to the method, in which the mixed resin layer doped with fluororesin granules could lower the dielectric constant and dielectric loss to lower the influence to the conductor from the mixed resin layer. The fluororesin is flame retardant, heat resistant, and corrosion resistant, which reduces the use of flame retardants.

### CROSS-REFERENCE TO RELATED APPLICATION

This application claims the priority benefit of Chinese Patent Application Serial Number 202110642614.X, filed on Jun. 9, 2021, the full disclosure of which is incorporated herein by reference.

### BACKGROUND

### Technical Field

The present disclosure relates to the technical field of high-frequency signals, particularly to a flexible flat cable manufacturing method and a flexible flat cable.

### Related Art

In the prior arts, most of the power cables for signal transmission comprises two layers of polyester insulating materials and a central conductor wire. The plugging components of two ends of the power cable can be used for connection according to user requirements. At present, in a flex flat cable (FFC), hot melt adhesive film is one of the three main materials for the flex flat cable, providing the capability of flame resistance, heat resistance, and insulation. Since the hot melt adhesive film needs to be filled with a large amount of flame retardant, which would increase the dielectric constant of the hot melt adhesive film and increase the dielectric loss, resulting in attenuation of high speed transmission signals.

### SUMMARY

The embodiments of the present disclosure provide a flexible flat cable manufacturing method and a flexible flat cable tended to reduce the use of flame retardants and to solve the problem of increasing dielectric constant and dielectric loss caused by hot melt adhesive films through a plurality of granules made of fluororesin disposed in the flexible flat cable.

On the first aspect, the present disclosure provides a method for manufacturing a flexible flat cable, comprising: obtaining a conductor; doping a granule made of fluororesin into a resin to produce a mixed resin, wherein the mixed resin covering the periphery of the conductor; covering the periphery of the mixed resin with a plastic film layer.

In one embodiment, the mixed resin is prepared by doping the resin with the granules made of fluororesin by a ratio between 10:90 and 90:10, preferably between 20:80 and 50:50.

In one embodiment, the resin is one or a mixture of more than one of modified ethylene-vinyl acetate copolymer, modified thermoplastic polyurethane, modified hydrogenated styrene-butadiene-styrene block copolymer, styrene-isoprene-styrene copolymer, styrene-butadiene-styrene block copolymer, modified polyolefin elastomer, maleic anhydride modified polybutadiene resin, amine modified polybutadiene resin, carboxyl modified polybutadiene resin, Hydroxyl modified polybutadiene resin, maleic anhydride modified butadiene styrene copolymer, acrylate modified butadiene and styrene copolymer, polyester, epoxy resin, and polyphenylene ether.

In one embodiment, the fluororesin is a tetrafluoroethylene resin, a tetrafluoroethylene-perfluoroalkoxyethylene copolymerization resin, a tetrafluoroethylene-hexafluoropropylene copolymer resin, a tetrafluoroethylene-ethylene copolymer resin, a difluoroethylene resin, a trifluoroethylene resin, or ethylene-trifluoroethylene resin.

In one embodiment, a surface of the granules made of fluorine resin is under surface treatment via fluorine conjugate treatment, potassium molten acetate modification, or naphthalene sodium solution modification.

In one embodiment, the size of the granules made of the fluorine resin is between 0.1 um and 50 um, preferably between 0.5 um and 30 um.

In one embodiment, the size of the granules made of the fluorine resin doped with the mixed resin are different, exactly the same, or not exactly the same.

In one embodiment, when the mixed resin is disposed on the periphery of the conductor, a substrate film covers the periphery of mixed resin, then the plastic film layer covers the periphery of the substrate film.

In one embodiment, the substrate film is a polyimide film, a polyether ether ketone film, a polyphenylene sulfide film, an aromatic polyamide film, a naphthanedikhalate film, a liquid crystal polymer film, or a polyethylene terephthalate film.

In one embodiment, the mixed resin is further doped with a thermoplastic resin, a tackifier, a flame retardant, a curing agent, a curing accelerator, a coupling reagent, an anti-thermal aging agent, a levelling agent, a defoaming agent, an inorganic filler, a pigment, and a solvent.

In one embodiment, an outer side of the plastic film layer is hot-pressed when the plastic film layer is covering on the periphery of the mixed resin, allowing the plastic film layer, the mixed resin, and the conductor to be tightly combined to form the flexible flat cable.

On the second aspect, the present disclosure provides a flexible flat cable, comprising a conductor, a mixed resin layer, and a plastic film layer. The mixed resin layer comprises a resin and a plurality of fluororesin granules doped in the resin. The mixed resin layer covers the periphery of the conductor. The plastic film layer covers the periphery of the mixed resin layer.

In one embodiment, the mixed resin layer comprises the resin and the plurality of fluororesin granules in a ratio between 10:90 and 90:10, preferably between 20:80 and 50:50.

In one embodiment, the size of each of the fluororesin granules is between 0.1 um and 50 um, preferably between 0.5 um and 30 um.

In one embodiment, a substrate film layer is further provided. The substrate film layer is disposed between the mixed resin layer and the plastic film layer.

In the embodiments of the present disclosure, by doping the granules made of fluororesin with the resin to produce a mixed resin, the dielectric constant of the fluororesin granules can be lower than that of the resin, and the fluororesin granules could effectively reduce the dielectric constant and dielectric loss of the resin to reduce the influence of mixed resin to the conductor. Since fluorine resin has great ability of flame retardance, heat resistance, and corrosion resistance, the using of flame retardants can be reduced.

It should be understood, however, that this summary may not contain all aspects and embodiments of the present disclosure, that this summary is not meant to be limiting or restrictive in any manner, and that the disclosure as disclosed herein will be understood by one of ordinary skill in the art to encompass obvious improvements and modifications thereto.

### BRIEF DESCRIPTION OF THE DRAWINGS

The features of the exemplary embodiments believed to be novel and the elements and/or the steps characteristic of the exemplary embodiments are set forth with particularity in the appended claims. The Figures are for illustration purposes only and are not drawn to scale. The exemplary embodiments, both as to organization and method of operation, may best be understood by reference to the detailed description which follows taken in conjunction with the accompanying drawings in which:

FIG. 1 is a flow chart showing the method for manufacturing a flexible flat cable of the present disclosure;

FIG. 2 is another flow chart of FIG. 1;

FIG. 3 is another flow chart of FIG. 1;

FIG. 4 is a processing schematic diagram of FIG. 3; and

FIG. 5 is a schematic diagram of the flexible flat cable of the present disclosure.

### DETAILED DESCRIPTION OF THE EMBODIMENTS

The present disclosure will now be described more fully hereinafter with reference to the accompanying drawings, in which exemplary embodiments of the disclosure are shown. This present disclosure may, however, be embodied in many different forms and should not be construed as limited to the embodiments set forth herein. Rather, these embodiments are provided so that this present disclosure will be thorough and complete, and will fully convey the scope of the present disclosure to those skilled in the art.

Certain terms are used throughout the description and following claims to refer to particular components. As one skilled in the art will appreciate, manufacturers may refer to a component by different names. This document does not intend to distinguish between components that differ in name but function. In the following description and in the claims, the terms “include/including” and “comprise/comprising” are used in an open-ended fashion, and thus should be interpreted as “including but not limited to”. “Substantial/substantially” means, within an acceptable error range, the person skilled in the art may solve the technical problem in a certain error range to achieve the basic technical effect.

The following description is of the best-contemplated mode of carrying out the disclosure. This description is made for the purpose of illustration of the general principles of the disclosure and should not be taken in a limiting sense. The scope of the disclosure is best determined by reference to the appended claims.

Moreover, the terms “include”, “contain”, and any variation thereof are intended to cover a non-exclusive inclusion. Therefore, a process, method, object, or device that includes a series of elements not only includes these elements, but also includes other elements not specified expressly, or may include inherent elements of the process, method, object, or device. If no more limitations are made, an element limited by “include a/an . . . ” does not exclude other same elements existing in the process, the method, the article, or the device which includes the element.

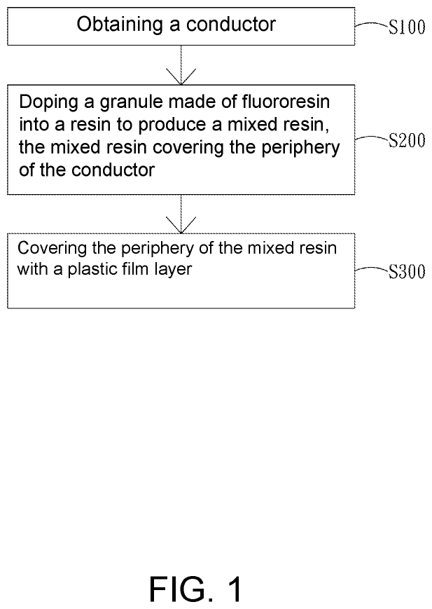

FIG. 1 is a flow chart showing the method for manufacturing a flexible flat cable of the present disclosure. As shown in the figure, a method for manufacturing a flexible flat cable is provided, comprising: step S100, obtaining a conductor; step S200, doping a granule made of fluororesin into a resin to produce a mixed resin, wherein the mixed resin covering the periphery of the conductor; step S300, covering the periphery of the mixed resin with a plastic film layer.

In this embodiment, in step S200 of doping a granule made of fluororesin into a resin to produce a mixed resin, a surface of the granules made of fluorine resin is under surface treatment via fluorine conjugate treatment, potassium molten acetate modification, or naphthalene sodium solution modification, wherein the size of the granules made of the fluorine resin doped with the mixed resin could be different, exactly the same, or not exactly the same. Preferred methods can be selected depending on the size or shape of the granules required. The size of the fluororesin granules is between 0.1 um and 50 um, preferably between 0.5 um and 30 um

Besides, the mixed resin is prepared by doping the resin with the granules made of fluororesin in a certain ratio, which is between 10:90 and 90:10, preferably between 20:80 and 50:50. In this embodiment, the dielectric constant of the granules made of fluororesin is smaller than that of the resin, wherein the dielectric constant of the granules made of fluororesin is between 1.8 and 2.4, and the dielectric constant of the resin is between 2.5 and 2.7. In this way, doping granules made of fluororesin in the resin could effectively reduce the overall dielectric constant and dielectric loss of the mixed resin, thereby reducing the influence from the mixed resin to the conductor.

In this embodiment, the fluororesin is a tetrafluoroethylene resin, a tetrafluoroethylene-perfluoroalkoxyethylene copolymer resin, a tetrafluoroethylene-hexafluoropropylene copolymer resin, a tetrafluoroethylene-ethylene copolymer resin, a vinylidene fluoride resin, a chlorotrifluoroethylene resin, or an ethylene-chlorotrifluoroethylene resin. The fluororesin is a tetrafluoroethylene resin, a tetrafluoroethylene-perfluoroalkoxyethylene copolymer resin, a tetrafluoroethylene-hexafluoropropylene copolymer resin, a tetrafluoroethylene-ethylene copolymer resin, a vinylidene fluoride resin, a chlorotrifluoroethylene resin, or an ethylene-chlorotrifluoroethylene resin. Besides, the resin is one or a mixture of more than one of a modified ethylene-vinyl acetate copolymer, a modified thermoplastic polyurethane, a modified hydrogenated styrene-butadiene-styrene block copolymer, a styrene-isoprene-styrene copolymer, a styrene-butadiene-styrene block copolymer, a modified polyolefin elastomer, a maleic anhydride modified polybutadiene resin, an amine modified polybutadiene resin, a carboxyl terminal modified polybutadiene resin, a hydroxyl terminal modified polybutadiene resin, a maleic anhydride modified butadiene styrene copolymer, an acrylate modified butadiene and styrene copolymer, a polyester, an epoxy resin, and a polyphenylene ether.

Besides, the mixed resin is doped with one or a combination of more than one of crystalline silica, amorphous silica, spherical silica, titanium dioxide, strontium titanate, barium titanate, boron nitride, aluminum nitride, silicon carbide, aluminum oxide, glass fiber, polytetrafluoroethylene, polyphenylene sulfide, and polyethersulfone. Besides, the mixed resin is further doped with one or a combination of thermoplastic resin, tackifier, flame retardant, curing agent, curing accelerator, coupling reagent, anti-thermal aging agent, leveling agent, defoaming agent, inorganic filler, pigment, and solvent.

Since the plurality of fluororesin granules doped with the adhesive layer is flame retardant, heat resistant, and corrosion resistant, the amount of addition and use of flame retardants can be reduced to a ratio lower than or equal to 10% out of the total weight of the adhesive layer. The flame retardant doped in the mixed resin is bromine or phosphorus flame retardant. The bromine flame retardant can be decabromodiphenyl ether, decabromodiphenylethane, or ethylene bistetrabromophthalimide. The bromine flame retardant can be tri (2,6-dimethylphenyl) phosphine, 10-(2,5-Dihydroxyphenyl)-9, 10-Dihydro-9-oxa-10-phosphinphenanthrene-10-oxide, 2,6-bi (2,6-dimethylphenyl) phosphinobenzene, or 10-Phenyl-9,10-dihydro-9-oxa-10-phosphinphenanthrene-10-oxide. Besides, flame retardant can be organic flame retardant and inorganic flame retardant. The organic flame retardant can be phosphorus flame retardant such as antimony trioxide, melamine phosphate, melamine polyphosphate, guanidine phosphate, guanidine polyphosphate, ammonium phosphate, ammonium polyphosphate, ammonium phosphate, ammonium polyphosphate, phosphoric acid carbamate, polyphosphoric acid carbamate, aluminum tridiethylphosphinate, aluminum trimethylethylphosphinate, aluminum tri sdiphenylphosphinate, zinc bisdiethylphosphinate, zinc bismethylethylphosphinate, zinc bisdiphenylphosphinate, titanium oxide bisdiethylphosphinate, titanium tetradiethylphosphinate, titanium oxide dimethyl ethyl phosphinate, Titanium tetramethyl ethyl phosphinate, titanium oxide bisdiphenylphosphinate, and titanium tetradiphenylphosphinate, and can be nitrogen flame retardant such as melamine, melam, triazine compounds such as melamine cyanurate, cyanuric acid compounds, isocyanuric acid compounds, triazole compounds, tetraazole compounds, diazonium compounds, and urea. The inorganic flame retardant can be metal hydroxides such as aluminum hydroxide, magnesium hydroxide, zirconium hydroxide, barium hydroxide, and calcium hydroxide; metal oxides such as tin oxide, aluminum oxide, magnesium oxide, zirconium oxide, zinc oxide, molybdenum oxide, and nickel oxide; and one or a combination of more than one of zinc carbonate, magnesium carbonate, barium carbonate, zinc borate, and hydrated glass. Moreover, the fluorine resin is a non-flammable resin, which is similar to flame retardant to reduce the proportion of flame retardant doped in the mixed resin. The fluorine resin is also an effective anti-dripping agent, which improves the flame retardancy and anti-dripping of the mixed resin.

In this embodiment, when the plastic film layer is a polyimide film (PI film), which is highly thermal resistant, the plastic film layer can be adaptive to an environment between −270° C. and 400° C. Since the polyimide film is highly insulative and is insoluble in organic solvents, it is not easy to be corroded. Thus, flexible flat cables whose plastic film layer is polyimide film do not need flame retardants as polyimide could work as a flame retardant.

Practically, in this embodiment, when the plastic film layer is flame-retardant, insulative, and corrosion-resistant, to or not to dope the flame retardants with the mixed resin can be decided according to user requirements. When the flame retardant is doped, the flame retardance, insulation, and corrosion resistance of the mixed resin would be enhanced to improve the flame retardance, insulation, and corrosion resistance for the entire flexible flat cable. When the plastic film layer is not doped with any materials that are flame retardant, insulative, and corrosion resistant, the mixed resin needs to be doped with flame retardants to allow flame retardance, insulation, and corrosion resistance to be enhanced.

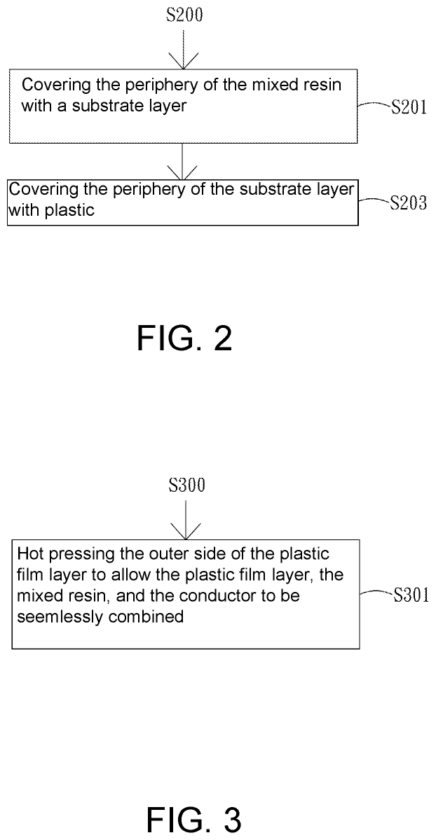

FIG. 2 is another flow chart of FIG. 1. As shown in the figure, when the step S200, doping a granule made of fluororesin into a resin to produce a mixed resin and covering the periphery of the conductor with the mixed resin, is processed, this embodiment further performs a step S201 to cover the periphery of the mixed resin with a substrate film, and a step S203 to cover the periphery of the substrate film with a plastic film layer. The substrate film can be a polyimide film, a polyetheretherketone film, a polyphenylene sulfide film, an aramid film, a polyethylene naphthalate film, a liquid crystal polymer film, or a polyethylene terephthalate film. In this embodiment, the substrate film works as an adhesive for covering the mixed resin with the plastic film layer.

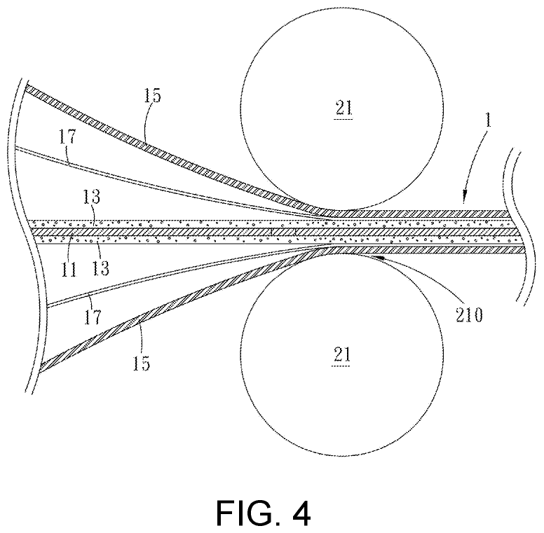

FIG. 3 is another flow chart of FIG. 1. FIG. 4 is a processing schematic diagram of FIG. 3. As shown in the figures, when performing the step S300, covering the periphery of the mixed resin with a plastic film layer, this embodiment further performs a step S301 to hot press on an outer side of the plastic film layer to allow the plastic film layer, the mixed resin, and the conductor to be seamlessly combined to form a flexible flat cable. Specifically, in this embodiment, the hot pressing is processed by two hot pressing roller bars 21, which are oppositely disposed across a hot pressing space 210. When the plastic film layer 15, the substrate film (the substrate film layer 17), the mixed resin (the mixed resin layer 13), and the conductor 11 pass through the hot pressing space 210 between the two hot pressing roller bars 21 at the same time, the two hot pressing roller bars 21 would press the outermost plastic film layer 15 inward and heat up the components in an order of the plastic film layer 15, the substrate film (the substrate film layer 17), and the mixed resin (the mixed resin layer 13) from the outside to the inside. In a period of time under hot pressing, the plastic film layer 15, the substrate film (the substrate film layer 17), and the mixed resin (the mixed resin layer 13) can be firmly bonded to the conductor 11, wherein the temperature of the hot pressing roller bar 21 is between 150° C. and 200° C., preferably 180° C., but the temperature of this embodiment is not limited and can be adjustable according to user requirements.

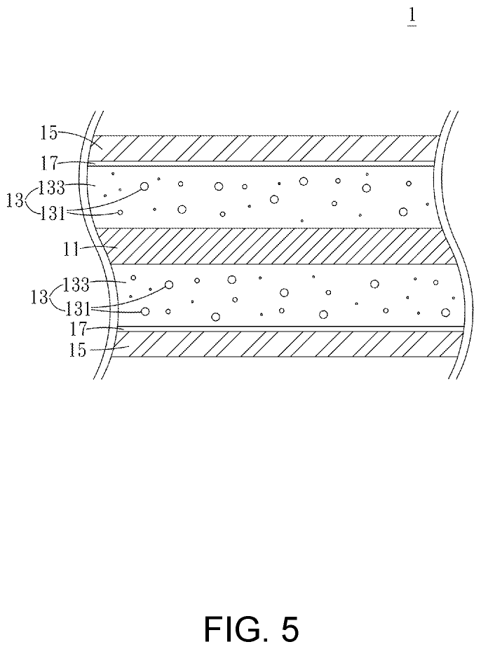

FIG. 5 is a schematic diagram of the flexible flat cable of the present disclosure. As shown in the figure, in this embodiment, a flexible flat cable 1 produced by the manufacturing method for flexible flat cable described above comprises a conductor 11, a mixed resin layer 13, and a plastic film layer 15. The mixed resin layer 13 comprises a plurality of fluororesin granules 131 and a resin 133. The plurality of fluororesin granules 131 are doped with the resin 133, as the size of the plurality of fluororesin granules 131 are the same, different, or not exactly the same. The mixed resin layer 13 covers the periphery of the conductor 11, and the plastic film layer 15 covers the periphery of the mixed resin layer 13. The flexible flat cable 1 further comprises a substrate film layer 17, which is disposed between the mixed resin layer 13 and the plastic film layer 15. In this embodiment, the substrate film layer 17 works as an adhesive when the plastic film layer 15 covers the mixed resin layer 13. Besides, it should be further explained is that, in this embodiment, the size of the plurality of fluororesin granules 131 are the same, different, or not exactly the same. When the size of the plurality of fluororesin granules 131 are different, the size of the plurality of fluororesin granules 131 in the mixed resin layer 13 would be completely different. When the size of the plurality of fluororesin granules 131 are the same, the size of the plurality of fluororesin granules 131 in the mixed resin layer 13 would be completely same. When the size of the plurality of fluororesin granules 131 are not exactly the same, the size of a part of the plurality of fluororesin granules 131 in the mixed resin layer 13 would be completely the same, and the rest of them would be different. Through the mentioned three possible configuration, the flame retardant, heat resistant, and corrosion resistant ability of the flexible flat cable could be improved.

Furthermore, the mixed resin layer 13 comprises the resin 133 and the plurality of fluororesin granules 131 in a ratio between 10:90 and 90:10, preferably between 20:80 and 50:50. The size of each of the fluororesin granules is between 0.1 um and 50 um, preferably between 0.5 um and 30 um. Besides, the shape of the fluororesin granules 131 can be, but not limited to, sphere, cone, rectangular, bar, or polygonal. Due to the shape variety, the contact surface between the fluororesin granules 131 and the mixed resin layer 13 varies, which indirectly affects the strength of bonding between the mixed resin layer 13 and the base film layer 17 and between the plastic film layer 15 and the base film layer 17 to be inconsistent.

In summary, embodiments of the present disclosure provide a flexible flat cable manufacturing method and a flexible flat cable. By doping the granules made of fluororesin with the resin to produce a mixed resin, the dielectric constant of the fluororesin granules can be lower than that of the resin, and the fluororesin granules could effectively reduce the dielectric constant and dielectric loss of the resin to reduce the influence of mixed resin to the conductor. Since the fluorine resin has great ability of flame retardance, heat resistance, and corrosion resistance, the using of flame retardants can be reduced.

It is to be understood that the term “comprises”, “comprising”, or any other variants thereof, is intended to encompass a non-exclusive inclusion, such that a process, method, article, or device of a series of elements not only comprise those elements but further comprises other elements that are not explicitly listed, or elements that are inherent to such a process, method, article, or device. An element defined by the phrase “comprising a . . . ” does not exclude the presence of the same element in the process, method, article, or device that comprises the element.

Although the present disclosure has been explained in relation to its preferred embodiment, it does not intend to limit the present disclosure. It will be apparent to those skilled in the art having regard to this present disclosure that other modifications of the exemplary embodiments beyond those embodiments specifically described here may be made without departing from the spirit of the disclosure. Accordingly, such modifications are considered within the scope of the disclosure as limited solely by the appended claims.

What is claimed is:

1. A method for manufacturing a flexible flat cable, comprising:
obtaining a conductor;
doping a granule made of fluororesin into a resin to produce a mixed resin, the mixed resin covering the periphery of the conductor; and
covering the periphery of the mixed resin with a plastic film layer.

2. The method for manufacturing a flexible flat cable according to claim 1, wherein the mixed resin is prepared by doping the resin with the granules made of fluororesin by a ratio between 10:90 and 90:10, preferably between 20:80 and 50:50.

3. The method for manufacturing a flexible flat cable according to claim 1, wherein the resin is one or a mixture of more than one of modified ethylene-vinyl acetate copolymer, modified thermoplastic polyurethane, modified hydrogenated styrene-butadiene-styrene block copolymer, styrene-isoprene-styrene copolymer, styrene-butadiene-styrene block copolymer, modified polyolefin elastomer, maleic anhydride modified polybutadiene resin, amine modified polybutadiene resin, carboxyl modified polybutadiene resin, Hydroxyl modified polybutadiene resin, maleic anhydride modified butadiene styrene copolymer, acrylate modified butadiene and styrene copolymer, polyester, epoxy resin, and polyphenylene ether.

4. The method for manufacturing a flexible flat cable according to claim 1, wherein the fluororesin is a tetrafluoroethylene resin, a tetrafluoroethylene-perfluoroalkoxyethylene copolymerization resin, a tetrafluoroethylene-hexafluoropropylene copolymer resin, a tetrafluoroethylene-ethylene copolymer resin, a difluoroethylene resin, a trifluoroethylene resin, or ethylene-trifluoroethylene resin.

5. The method for manufacturing a flexible flat cable according to claim 1, wherein a surface of the granules made of fluorine resin is under surface treatment via fluorine conjugate treatment, potassium molten acetate modification, or naphthalene sodium solution modification.

6. The method for manufacturing a flexible flat cable according to claim 1, wherein the size of the granules made of the fluorine resin is between 0.1 um and 50 um, preferably between 0.5 um and 30 um.

7. The method for manufacturing a flexible flat cable according to claim 1, wherein the size of the granules made of the fluorine resin doped with the mixed resin are different, exactly the same, or not exactly the same.

8. The method for manufacturing a flexible flat cable according to claim 1, wherein when the mixed resin is disposed on the periphery of the conductor, a substrate film covers the periphery of mixed resin, then the plastic film layer covers the periphery of the substrate film.

9. The method for manufacturing a flexible flat cable according to claim 8, wherein the substrate film is a polyimide film, a polyether ether ketone film, a polyphenylene sulfide film, an aromatic polyamide film, a naphthanedikhalate film, a liquid crystal polymer film, or a polyethylene terephthalate film.

10. The method for manufacturing a flexible flat cable according to claim 1, wherein the mixed resin is further doped with a thermoplastic resin, a tackifier, a flame retardant, a curing agent, a curing accelerator, a coupling reagent, an anti-thermal aging agent, a levelling agent, a defoaming agent, an inorganic filler, a pigment, and a solvent.

11. The method for manufacturing a flexible flat cable according to claim 1, wherein an outer side of the plastic film layer is hot-pressed when the plastic film layer is covering on the periphery of the mixed resin, allowing the plastic film layer, the mixed resin and the conductor to be tightly combined to form the flexible flat cable.

12. A flexible flat cable, comprising:
a conductor;
a mixed resin layer comprising a resin and a plurality of fluororesin granules doped in the resin, the mixed resin layer covering the periphery of the conductor; and
a plastic film layer covering the periphery of the mixed resin layer.

13. The electrical connector according to claim 12, wherein the mixed resin layer comprises the resin and the plurality of fluororesin granules in a ratio between 10:90 and 90:10, preferably between 20:80 and 50:50.

14. The electrical connector according to claim 12, wherein the size of each of the fluororesin granules is between 0.1 um to 50 um, preferably between 0.5 um to 30 um.

15. The electrical connector according to claim 12 comprising a substrate film layer disposed between the mixed resin layer and the plastic film layer.
